(19) United States
(12) Patent Application Publication
(10) Pub. No.: US 2023/0406170 A1
(43) Pub. Date: Dec. 21, 2023

(54) A-LOK PLASTIC CAM WITH ALUMINUM TOOTH INSERT

(71) Applicant: Indiana Mills & Manufacturing, Inc., Westfield, IN (US)

(72) Inventor: Brian Nelson Coffman, Westfield, IN (US)

(73) Assignee: Indiana Mills & Manufacturing, Inc., Westfield, IN (US)

(21) Appl. No.: 18/459,095

(22) Filed: Aug. 31, 2023

Related U.S. Application Data
(63) Continuation of application No. PCT/US2022/070934, filed on Mar. 3, 2022.

(51) Int. Cl. B60N 2/28; B60R 22/19; B60R 22/26

(52) U.S. Cl. CPC B60N 2/2816; B60R 2022/1806; B60R 22/26; B60R 22/19

(57) ABSTRACT

A harness adjuster configured to secure webbing of a child car seat. The adjuster includes a frame, a lever assembly, and a shaft configured to secure the lever assembly within the frame. The lever assembly further includes a lever portion and a web engagement portion. The web engagement portion is configured to secure a toothed insert via a tongue and groove connection. In one embodiment, the lever portion and the toothed insert are made from different materials. For example, the lever portion is made from a plastic and/or polymeric material and the toothed insert is made from a metallic material.

### CROSS REFERENCE TO RELATED APPLICATIONS

This application is a continuation of International Patent Application Number PCT/US2022/070934, filed Mar. 3, 2022, which is hereby incorporated by reference. International Patent Application Number PCT/US2022/070934, filed Mar. 3, 2022, claims the benefit of U.S. Patent Application No. 63/200,369, filed Mar. 3, 2021, which are hereby incorporated by reference.

### BACKGROUND

Child safety seats or car seats are designed to protect children when in a vehicle. Typically, a child occupant is secured in the seat via a harness. To ensure occupant safety and comfort, the harness needs to be properly tensioned. In some designs, harness adjusters are used to adjust and maintain the tension of the harness. While accidents are rare, the harness adjuster needs to maintain proper tension of the harness during any accident. At the same time, the harness adjuster needs to be easily actuated to facilitate easy loosening of the harness such as when the child occupant is removed from the seat.

Thus, there is a need for improvement in this field.

### SUMMARY

As was recognized during the development of this design, child safety seats can be expensive to manufacture. This high manufacturing cost in turn can limit the practical availability of child safety seats to lower income families. For example, a central front adjuster (CFA) and/or other types of harness adjusters, which are commonly found on child safety seats, are generally made from high-strength metals. These high-strength metals can be quite expensive to manufacture which in turn increases the cost of the child safety seat. To provide smooth and easy actuation, the CFA includes bushings, bearings, and/or lubricants to reduce friction between the moveable metal components of the CFA.

Typically, but not always, the CFA is positioned between the legs of the child when seated in the child safety seat. Vehicle cabin temperatures can be quite hot such as during the summer or even when the seat is exposed to high sunlight conditions. Due to the conductive nature of the metal used to form the CFA, the CFA can likewise become hot which in turn can lead to the child occupant burning their legs or other body parts. Likewise, an individual when adjusting the harness can experience severe discomfort or even burns caused by the hot, metal CFA.

A unique harness adjuster has been developed to address the above-mentioned as well as other issues. In one embodiment, the harness adjuster is configured to secure harness webbing or belts of a child safety seat. The adjuster includes a frame, a lever assembly, and a shaft configured to pivotally secure the lever assembly within the frame. In the harness adjuster, the lever assembly has a unique two-component material or composite design. In one example, the lever assembly has an engagement portion configured to secure a belt of a harness and a lever portion that is actuatable to engage and disengage the engagement portion with the belt of the harness. The engagement portion and the lever portions in one variation are made from different materials.

By being made from two different materials, the overall cost of the harness adjuster can be reduced and the function of the adjuster can be enhanced. For instance, critical failure components may be made from more expensive materials and less critical parts may be made from less expensive materials. With the less critical parts being made from inexpensive materials, the critical components can be then also strengthened such that the overall cost of the adjuster remains the same. This two-component or multiple-material design can be used to reduce the risk of burns or discomfort when the adjuster is exposed to hot environments. For example, components requiring significant strength, such as the frame and shaft, are made from relatively strong materials like metallic materials. Certain portions of parts, like the lever assembly, can have a composite material design where certain parts are made from different materials.

As noted before, the harness adjuster is designed to reduce the risk of burns. In one variation, the engagement portion of the lever assembly is made from a thermally conductive material such as a metallic material and the lever portion is made from a thermally insulative material such as a polymeric material. In particular, the engagement portion in one form is made from metal, such as steel or aluminum, and the lever portion is made of plastic that is injection molded to form the part. The engagement portion in one form has teeth designed to engage the belt. In one version, the engagement portion is in the form of a toothed insert that is coupled to the lever portion. The toothed insert is connected to the lever portion via a tongue and groove type connection. In one embodiment, the lever portion and the toothed insert are made from different materials. For example, the lever portion is made from a plastic and/or polymeric material and the toothed insert is made from a metallic material. In one example, the toothed insert is made from aluminum. As should be appreciated, the toothed insert is removable via the tongue and groove connection. For example, the toothed insert may be replaced if damaged and replaced with a new insert to save costs.

To compensate for the relative strength differences between the materials, the lever assembly has a unique design. The toothed insert has a pair of opposing lobes that are received into opposing cutouts in a groove formed in the lever portion. Between the lobes, the toothed insert has a curved surface or arcuate portion that is positioned proximal to the shaft. When the harness adjuster is assembled, the lobes of the insert are located on opposing sides of the shaft, and the curvature of the arcuate portion generally coincides with the curvature of the shaft. The insert is sized and positioned at an acute angle relative to the frame. When tension is applied to the belt so as to restrain the seat occupant, the force vector of the insert extends generally through the shaft. While a curved portion of the plastic lever portion is sandwiched in between the insert and the shaft, the curved portion is generally placed under compression such that most of the force is applied between the insert and the shaft. As noted before, the insert and shaft are made from a relatively strong material, like metal, such that the tensioning force is predominantly applied through the metal insert and shaft. This in turn allows less critical components, such as the lever portion, to be made from inexpensive polymer materials like plastic.

In one version, the lever portion of the lever assembly engages and pivots about the shaft during actuation. The lever portion in one form has a shaft opening or aperture that receives the shaft. With the lever portion being made of plastic, the lever portion is able to smoothly pivot about the metallic shaft without the need of extra components like bushings, bearings, and/or lubricants. By eliminating the need for these extra components, the overall cost of the harness adjuster is reduced.

The harness adjuster further includes a coil spring circumferentially wound around the shaft that biases the lever assembly to engage the belt. The spring includes a first end in contact with the web engagement portion of the lever assembly and a second end mounted to the frame. The spring is configured to apply a biasing force to the lever assembly. As should be appreciated, the biasing force is configured to secure the harness or adjuster belt of the child safety seat in the harness adjuster. When secured, the belt is compressed between the frame and the toothed insert of the lever assembly. The teeth of the insert are able to bite into the belt so as to ensure a firm connection. To release the belt, an individual depresses the lever portion or otherwise applies force to the lever portion of the lever assembly to overcome the biasing force of the spring. As a result, the lever assembly pivots about the shaft, and the insert disengages from the belt so as to allow adjustment of the belt.

The system and techniques as described and illustrated herein concern a number of unique and inventive aspects. Some, but by no means all, of these unique aspects are summarized below.
Aspect 1 generally concerns a system that includes a harness adjuster.
Aspect 2 generally concerns the system of any previous aspect in which the shaft.
Aspect 3 generally concerns the system of any previous aspect in which the frame.
Aspect 4 generally concerns the system of any previous aspect in which the lever assembly.
Aspect 5 generally concerns the system of any previous aspect in which the lever assembly includes a lever portion and a web engagement portion.
Aspect 6 generally concerns the system of any previous aspect in which the web engagement portion includes a removable insert.
Aspect 7 generally concerns the system of any previous aspect in which the shaft is configured to retain the lever assembly within the frame.
Aspect 8 generally concerns the system of any previous aspect in which the shaft is made of metal.
Aspect 9 generally concerns the system of any previous aspect in which the lever portion defines an opening where the shaft is received.
Aspect 10 generally concerns the system of any previous aspect in which the harness adjuster is made from two different materials.
Aspect 11 generally concerns the system of any previous aspect in which the adjuster includes a lever assembly with a lever portion and a web engagement portion.
Aspect 12 generally concerns the system of any previous aspect in which the web engagement portion includes an elongated groove configured to retain a toothed insert.
Aspect 13 generally concerns the system of any previous aspect in which the lever portion and toothed insert are made from the two different materials.
Aspect 14 generally concerns the system of any previous aspect in which the toothed insert is made from metal.
Aspect 15 generally concerns the system of any previous aspect in which the toothed insert includes a tongue portion held within the elongated groove.
Aspect 16 generally concerns the system of any previous aspect in which the tongue portion is configured prevent rotation of the lever portion when force is applied to harness webbing.
Aspect 17 generally concerns the system of any previous aspect in which the lever portion is made from plastic.
Aspect 18 generally concerns the system of any previous aspect in which the adjuster includes a frame configured to retain the lever assembly via a shaft.
Aspect 19 generally concerns the system of any previous aspect in which the lever assembly rotates about an axis formed by the shaft.
Aspect 20 generally concerns the system of any previous aspect in which the shaft is configured to extend through an elongated aperture defined by the lever assembly.
Aspect 21 generally concerns the system of any previous aspect in which the shaft is configured to receive a circumferentially wound spring extending from the lever assembly to the frame.
Aspect 22 generally concerns the system of any previous aspect in which the spring is configured to bias the toothed insert of the web engagement portion into contact with the harness webbing to prevent movement of the harness webbing.
Aspect 23 generally concerns the system of any previous aspect in which the harness adjuster is a car seat harness adjuster.
Aspect 24 generally concerns a method of operating the system of any previous aspect.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a partial exploded view of a child safety seat including a harness adjuster.

FIG. 2 is a perspective view of the child safety seat including the harness adjuster of FIG. 1.

FIG. 3 is a perspective view of the harness adjuster.

FIG. 4 is a top view of the harness adjuster of FIG. 3.

FIG. 5 is a cross-sectional view of the harness adjuster taken along a line of FIG. 4

FIG. 6 is an exploded view of the harness adjuster of FIG. 3.

FIG. 7 is a perspective view of components of the harness adjuster of FIG. 3.

FIG. 8 is a perspective view of components of the harness adjuster of FIG. 3.

FIG. 9 is a perspective view of components of the harness adjuster of FIG. 3.

FIG. 10 is a perspective view of a lever assembly of the harness adjuster.

FIG. 11 is a perspective view of an insert of the harness adjuster.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

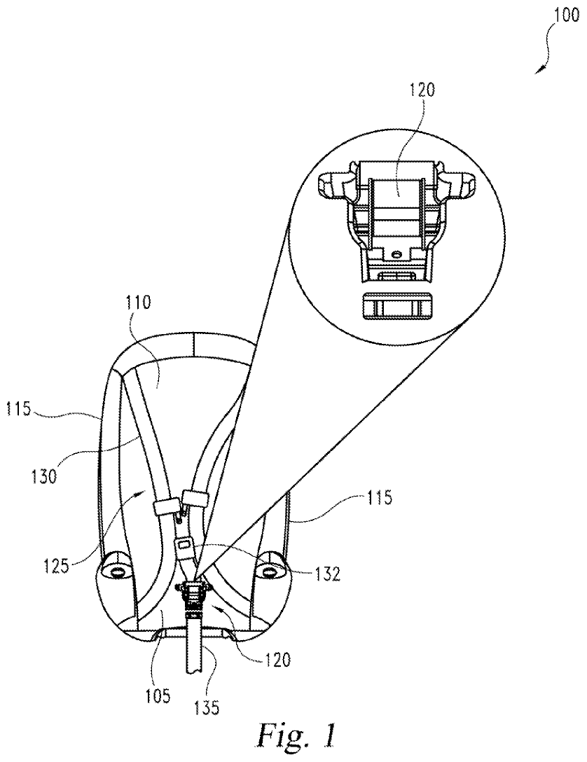

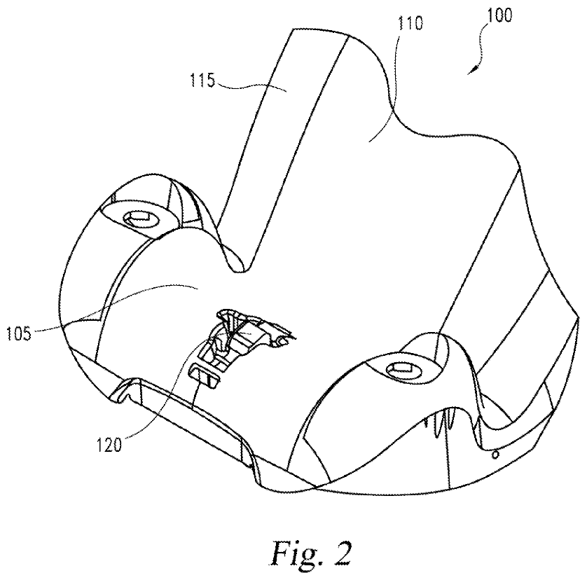

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

FIGS. 1 and 2 show one example of a child safety seat 100 where a child or other individual is seated. The child safety seat 100 includes a seat bottom 105, a seat back 110, a seat body 115, a harness adjuster 120, and a harness 125. The harness 125 is configured to secure the child in the child safety seat 100, and the harness adjuster 120 is used to adjust the tension of the harness 125. The harness 125 includes one or more shoulder belts 130 configured to secured the child, a buckle 132 configured to buckle the harness 125, and an adjustment belt 135 that is fed through the harness adjuster 120. Through the harness adjuster 120, the adjustment belt 135 extends underneath the seat bottom 105. Behind the seat back 110, the adjustment belt 135 is coupled to the shoulder belts 130.

The harness adjuster 120 and the adjustment belt 135 are used to adjust the tension of the shoulder belts 130 of the harness 125. For example, pulling on the adjustment belt 135 helps to tighten the harness 125. The harness adjuster 120 is designed to hold the harness 125 in the snugger, tensioned position so as to restrain the child in the child safety seat 100. Actuating the harness adjuster 120, releases the adjustment belt 135 so that the shoulder belts 130 can be loosened. In other words, the harness adjuster 120 is configured to enable a user to adjust a length of the adjustment belt 135 to adjust the fit of the harness 125. For example, the user may tighten the harness 125 and/or loosen the harness 125 based on the size and/or comfort of a child. In one embodiment, the harness adjuster 120 is configured to allow unidirectional movement of the adjustment belt 135. For example, the harness adjuster 120 allows tightening of the adjustment belt 135, but resists loosening of the adjustment belt 135. Generally, a button and/or lever is positioned on the harness adjuster 120 to enable a user to loosen the harness 125. As should be appreciated, preventing the harness 125 from loosening is a safety feature designed to prevent the child from getting loose in the child safety seat 100.

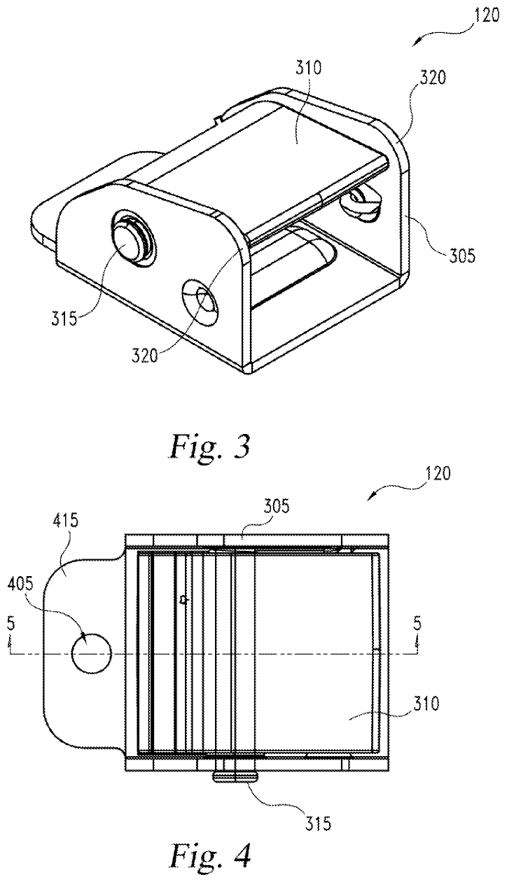

FIGS. 3 and 4 show an example of the harness adjuster 120. The harness adjuster 120 includes a frame 305, a lever assembly 310, and a shaft 315. The shaft 315 is configured to extend through the frame 305 and the lever assembly 310 to retain the lever assembly 310 within the frame 305. For example, the lever assembly 310 is sandwiched between a pair of opposing sidewalls 320. Generally, the frame 305 and the shaft 315 are made from a metallic and/or metal material, such as aluminum and/or steel. However, in other embodiments, the frame 305 and the shaft 315 are made from a polymeric and/or plastic material. The harness adjuster 120 further includes an aperture 405 defined in a base 415 of the frame 305. The aperture 405 is configured to enable mounting of the harness adjuster 120 onto the child safety seat 100. In one example, the harness adjuster 120 mounts to the seat bottom 105 of the child safety seat 100 via a fastener and/or an adhesive. In some specific embodiments, the harness adjuster 120 mounts to the seat bottom 105 of the child safety seat 100 and is known as a central front adjuster (CFA).

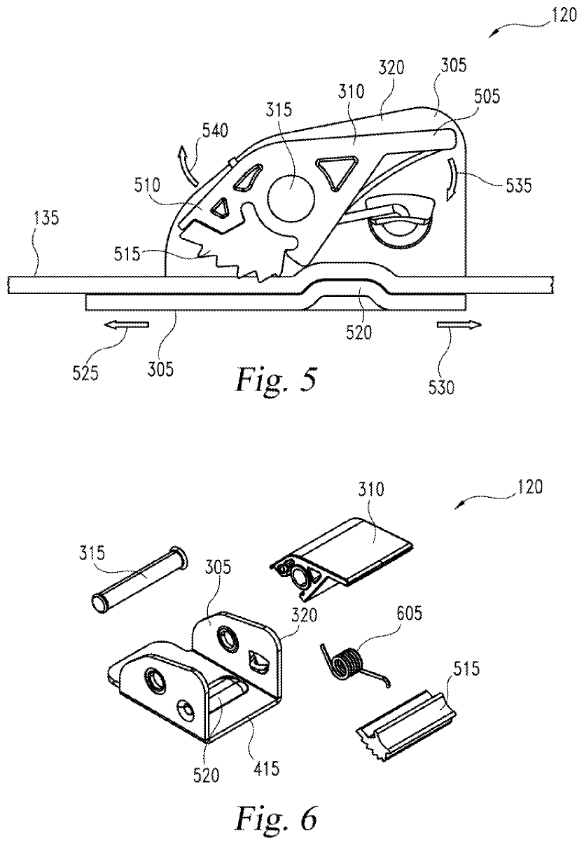

FIG. 5 shows a cross-sectional view of the harness adjuster 120 along line 4-4 in FIG. 4. As shown, the lever assembly 310 includes a lever portion 505 and a belt engagement portion 510. The belt engagement portion 510 further includes a removable insert 515 and a hump 520 configured to secure the adjustment belt 135. In one example, the adjustment belt 135 is coupled to the shoulder belts 130 of the harness 125. In one embodiment, the lever assembly 310 and the insert 515 are made from two different materials to facilitate cost savings while maintaining strength. For example, the lever assembly 310 is made from a polymeric material and the insert 515 is made from a metallic material. In another example, the lever portion 505 is made from plastic and the insert 515 is made from aluminum. Plastic is typically insulative such that the lever portion 505 does not significantly conduct heat. With the lever portion 505 made of plastic, the risk of burning is reduced when actuating the lever assembly 310. Moreover, with the belt engagement portion 510 being made from metal, the insert 515 provides significant strength for engaging the adjustment belt 135.

The lever portion 505 of the lever assembly 310 enables rotational movement of the lever assembly 310 about an axis formed by the shaft 315. Once more, the shaft 315 is made of metal and the lever portion 505 is made of plastic in one version. Such a configuration eliminates the need for extra bushings or bearings because the plastic lever portion 505 is able to smoothly rotate about the shaft 315.

In one version, applying force as indicated by arrow 535 to the lever portion 505 raises the belt engagement portion 510 as indicated by arrow 540. As the belt engagement portion 510 raises, the insert 515 loses contact with the adjustment belt 135. As should be appreciated, the loss of contact between the insert 515 and the adjustment belt 135 frees movement of the adjustment belt 135. For example, the adjustment belt 135 is able to be both tightened and/or loosed as indicated by arrow 525 and arrow 530. However, when no force is applied to the lever portion 505, the insert 515 is in direct contact with the adjustment belt 135. Thus, the adjustment belt 135 is able to move freely as indicated by arrow 525, but is restricted from moving as indicated by arrow 530. As should be appreciated, the hump 520 directs the adjustment belt 135 slightly upwards into the insert 515 when pulling from the direction indicated by arrow 530. Thus, movement of the adjustment belt 135 is prevented.

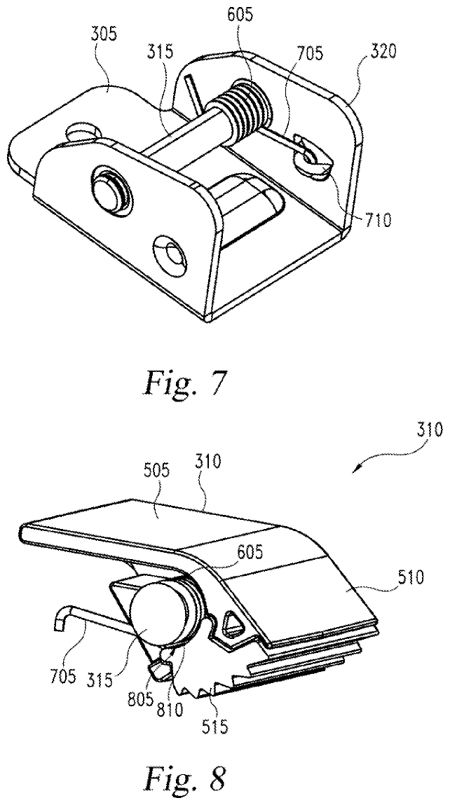

FIG. 6 shows an exploded view of the harness adjuster 120. As can be seen in FIG. 6, the harness adjuster 120 includes a spring 605. As shown in FIG. 7, the spring 605 is generally circumferentially wrapped around the shaft 315. The spring 605 further includes a spring arm 705 configured to nest within a retention opening 710 of the sidewalls 320. As should be appreciated, the spring 605 is configured to bias the belt engagement portion 510 of the lever assembly 310 into contact with the adjustment belt 135. However, as best descried in FIG. 5, applying a force to the lever portion 505 of the lever assembly 310 can overcome the biasing force of the spring 605 to separate the insert 515 from the adjustment belt 135. Thus, enabling free movement of the adjustment belt 135.

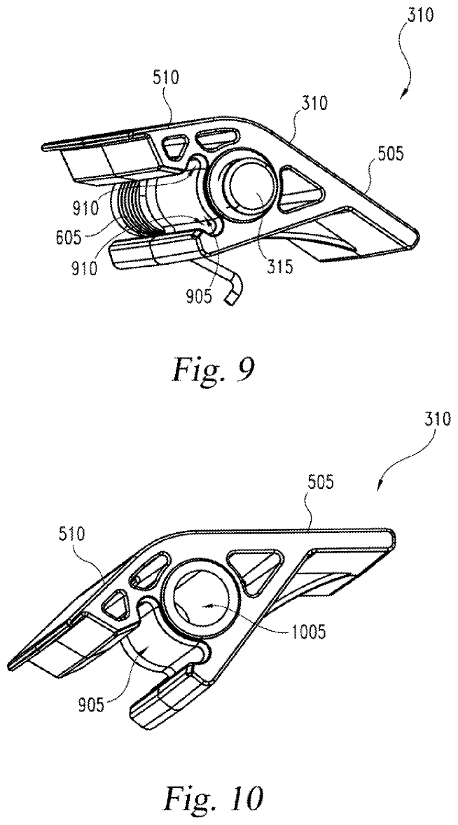

FIGS. 8 and 9 show opposing side views of the lever assembly 310. As can be seen in FIG. 8, the shaft 315 is configured to extend through the lever assembly 310. Additionally, the spring 605 is shown circumferentially wrapped around the shaft 315. The insert 515 further includes an arcuate portion 810. The arcuate portion 810 and the shaft 315 form a gap 805. The gap 805 is configured to enable some deformation and/or movement of the insert 515. For example, when the adjustment belt 135 is pulled as indicated by arrow 530 (FIG. 5), the insert 515 is able to flex and avoid scraping, cutting, and/or damaging the adjustment belt 135. Additionally, the insert 515 includes a lock-up function configured to prevent rotation of the lever assembly 310 about the shaft 315 during periods of high force. For example, the insert 515 crushes and/or presses the arcuate portion 810 into the shaft 315 to prevent rotation. As should be appreciated, the lock-up function is configured to prevent loosening of the harness 125 in the event of a collision.

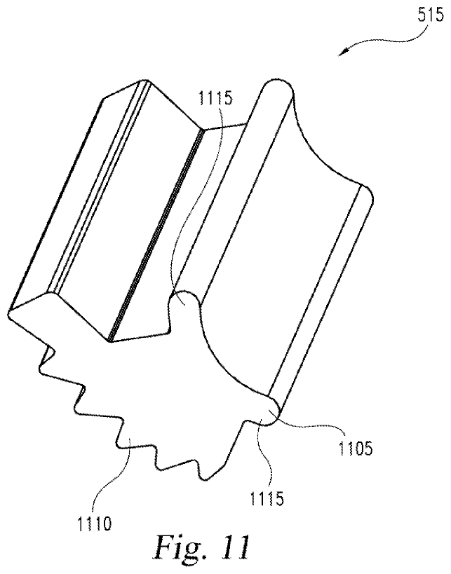

As shown in FIGS. 9, 10, and 11, the belt engagement portion 510 of the lever assembly 310 includes a groove 905. The groove 905 is configured to receive a tongue 1105 of the insert 515 and secure the insert 515 via a tongue and groove connection. The groove 905 further includes a pair of cutouts 910 configured to mate with a pair of lobes 1115 of the insert 515. The cutouts 910 and lobes 1115 prevent the insert 515 from pulling outward and/or coming loose from the belt engagement portion 510. As best shown in FIG. 10, the lever assembly 310 includes an elongated bore 1005 configured to receive the shaft 315. As best shown in FIG. 11, the insert 515 includes one or more teeth 1110. The teeth 1110 are configured to contact the adjustment belt 135 and prevent movement of the adjustment belt 135.

To compensate for the relative strength differences between the materials, the lever assembly 310 has a unique design. The toothed insert 515 has the pair of opposing lobes 1115 that are received into opposing cutouts 910 in the groove 905 formed in the lever portion 505. Between the lobes, the insert 515 has the arcuate portion 810 that is positioned proximal to the shaft 315. When the harness adjuster 120 is assembled, the lobes 1115 of the insert 515 are located on opposing sides of the shaft 315, and the curvature of the arcuate portion 810 generally coincides with the curvature of the shaft 315. The insert 515 is sized and positioned at an acute angle relative to the frame 305. When tension is applied to the adjustment belt 135 so as to restrain the seat occupant, the force vector of the insert 515 extends generally through the shaft 315. While a curved portion of the plastic lever portion 505 is sandwiched in between the insert 515 and the shaft 315, the curved portion is generally placed under compression such that most of the force is applied between the insert 515 and the shaft 315. As noted before, the insert 515 and shaft 315 are made from a relatively strong material, like metal, such that the tensioning force is predominantly applied through the metal insert 515 and shaft 315. This in turn allows less critical components, such as the lever portion 505, to be made from inexpensive polymeric materials like plastic.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“About” with reference to numerical values generally refers to plus or minus 10% of the stated value. For example, if the stated value is 4.375, then use of the term “about 4.375” generally means a range between 3.9375 and 4.8125.

“And/Or” generally refers to a grammatical conjunction indicating that one or more of the cases it connects may occur. For instance, it can indicate that either or both of two stated cases can occur. In general, “and/or” includes any combination of the listed collection. For example, “X, Y, and/or Z” encompasses: any one letter individually (e.g., {X}, {Y}, {Z}); any combination of two of the letters (e.g., {X, Y}, {X, Z}, {Y, Z}); and all three letters (e.g., {X, Y, Z}). Such combinations may include other unlisted elements as well.

“Axis” generally refers to a straight line about which a body, object, and/or a geometric figure rotates or may be conceived to rotate.

“Buckle” generally refers to device, such as in the form of a clasp, that releasably secures two or more loose ends together. Typically, but not always one end is secured to or otherwise attached to the clasp device, and the other end is releasably or adjustably held by the clasp device. The ends can be for a variety of objects such as straps, belts, cables, and webbing, to name just a few. One common type of buckle is a seat belt buckle found in a wide variety of vehicles. For instance, the buckle can be used in two-point, three-point, four-point, five-point, or six-point harness systems. In one example, the loose end of a seat belt is looped through a slot in a latch plate that includes a tongue, and to secure the loose end, the tongue is inserted into a seat belt buckle that is attached to a fixed seat belt or webbing.

“Child Safety Seat”, “Car Seat”, or “Child Restraint System” generally refer to a seat that is specifically designed to protect children from injury during a vehicle collision. Commonly, the child safety seat is an aftermarket product that is installed by an owner into a vehicle after purchase of the vehicle, but the child safety seat can be also integrated into a seat of the vehicle by a manufacturer of the vehicle. In contrast to most vehicle seats, which are designed to accommodate adults, the child safety seat is sized and configured to properly position a child or infant to reduce injury during an accident. The child safety further typically includes a passive restraint system, such as a harness, that generally hold an occupant of the seat in place during a collision. The restraint system for example can include a five-point harness, but other types of harnesses and restraints can be used. When sold as a separate, aftermarket product, the child safety seat can include an anchoring mechanism, like an Isofix connecter, configured to secure the child safety seat to the vehicle (e.g., via an Isofix anchor in the vehicle). Some typical types of child safety seats include infant seats, convertible seats, combination seats, and booster seats, just to name a few.

“Fastener” generally refers to a hardware device that mechanically joins or otherwise affixes two or more objects together. By way of non-limiting examples, the fastener can include bolts, dowels, nails, nuts, pegs, pins, rivets, screws, buttons, hook and loop fasteners, and snap fasteners, to just name a few.

“Five-Point Harness” generally refers to a restraint system that includes five straps or web portions that are mounted to a seat. Two of the straps are typically located to secure at the shoulders of an occupant of the seat, and another two of the straps are typically located proximal the hips of the occupant when seated. One of the straps is located at the crotch of the occupant when seated in the seat, and this strap typically includes a releasable buckle or other similar mechanism that releasable secures the five straps together so as to secure the occupant in the seat. The straps can be tightened or loosened depending on the size of the occupant and/or whether the occupant is being secured or removed from the seat. Five-point harnesses can be for example integrated into race car seats or child safety seats.

“Frame” generally refers to a structure that forms part of an object and gives strength and/or shape to the object.

“Harness” generally refers to a set of straps and fittings for fastening a human or other animal in a particular place and/or position. The straps can come on many forms, such as belts, webbing, or ropes, and the straps can be made of a variety of materials such as natural or synthetic materials. The fittings are designed in a variety of forms for securing the straps around the individual as well as releasing the straps to free the individual. The harness can include webbing, buckles, latch plates, and/or length-adjustment mechanisms, such as a retractor. In one example, the fitting includes a set of latch plates that are secured in a buckle release mechanism. Harnesses can for instance be integrated into vehicle seats, child booster seats, and child safety seats. The straps and fitting can be configured in a number of manners such as to form three-point, five-point, and six-point harnesses, to name just a few examples.

“Hole” generally refers to a hollow portion through a solid body, wall or a surface. A hole may be any shape. For example, a hole may be, but is not limited to, circular, triangular, or rectangular. A hole may also have varying depths and may extend entirely through the solid body or surface or may extend through only one side of the solid body.

“Latch Plate” generally refers to a part of a vehicle belt assembly that releasably connects to a buckle and through which the webbing is threaded or otherwise secured. Typically, but not always, the latch plate is in at least part made of metal and/or plastic. The latch plate includes one or more tongues that are inserted into the buckle. Each tongue can include a notch or other opening that is used to secure the latch plate to the buckle. By way of non-limiting examples, the latch plates can include free-sliding latch plates, cinching latch plates, locking latch plates, and switchable latch plates, to name just a few examples.

“Lever” generally refers to a simple machine including a beam, rod, or other structure pivoted at a fulcrum, such as a hinge. In one form, the lever is a rigid body capable of rotating on a point on itself. Levers can be generally categorized into three types of classes based on the location of fulcrum, load, and/or effort. In a class 1 type of lever, the fulcrum is located in the middle such that the effort is applied on one side of the fulcrum and the resistance or load on the other side. For class 1 type levers, the mechanical advantage may be greater than, less than, or equal to 1. Some non-limiting examples of class 1 type levers include seesaws, crowbars, and a pair of scissors. In a class 2 type of lever, which is sometimes referred to as a force multiplier lever, the resistance or load is located generally near the middle of the lever such that the effort is applied on one side of the resistance and the fulcrum is located on the other side. For class 2 type levers, the load arm is smaller than the effort arm, and the mechanical advantage is typically greater than 1. Some non-limiting examples of class 2 type levers include wheelbarrows, nutcrackers, bottle openers, and automobile brake pedals. In a class 3 type lever, which is sometimes referred to as a speed multiplier lever, the effort is generally located near the middle of the lever such that the resistance or load is on one side of the effort and the fulcrum is located on the other side. For class 3 type levers, the effort arm is smaller than the load arm, and the mechanical advantage is typically less than 1. Some non-limiting examples of class 3 type levers include a pair of tweezers and the human mandible.

“Metallic” generally refers to a material that includes a metal, or is predominately (50% or more by weight) a metal. A metallic substance may be a single pure metal, an alloy of two or more metals, or any other suitable combination of metals. The term may be used to refer to materials that include nonmetallic substances. For example, a metallic cable may include one or more strands of wire that are predominately copper sheathed in a polymer or other nonconductive material.

“Plastic” has the meaning, polymer or monomer material.

“Seat Belt”, “Safety Belt”, “Vehicle Belt”, or “Belt” generally refers to an arrangement of webs, straps, and other devices designed to restrain or otherwise hold a person or other object steady such as in a boat, vehicle, aircraft, and/or spacecraft. For example, the seat belt is designed to secure an occupant of a vehicle against harmful movement that may result during a collision or a sudden stop. By way of non-limiting examples, the seat belt can include webbing, buckles, latch plates, and/or length-adjustment mechanisms, such as a retractor, installed in the vehicle that is used to restrain an occupant or a child restraint system. The seat belt for instance can include a lap belt only, a combination lap-shoulder belt, a separate lap belt, a separate shoulder belt, and/or a knee bolster.

“Spring” generally refers to an elastic object that stores mechanical energy. The spring can include a resilient device that can be pressed, pulled, and/or twisted but returns to its former shape when released. The spring can be made from resilient or elastic material such as metal and/or plastic. The spring can counter or resist loads in many forms and apply force at constant or variable levels. For example, the spring can include a tension spring, compression spring, torsion spring, constant spring, and/or variable spring. The spring can take many forms such as by being a flat spring, a machined spring, and/or a serpentine spring. By way of nonlimiting examples, the springs can include various coil springs, pocket springs, Bonnell coils, offset coils, continuous coils, cantilever springs, volute springs, hairsprings, leaf springs, V-springs, gas springs, leaf springs, torsion springs, rubber bands, spring washers, and/or wave springs, to name just a few.

“Vehicle” generally refers to a machine that transports people and/or cargo. Common vehicle types can include land-based vehicles, amphibious vehicles, watercraft, aircraft, and space craft. By way of non-limiting examples, land-based vehicles can include wagons, carts, scooters, bicycles, motorcycles, automobiles, buses, trucks, semi-trailers, trains, trolleys, and trams. Amphibious vehicles can for example include hovercraft and duck boats, and watercraft can include ships, boats, and submarines, to name just a few examples. Common forms of aircraft include airplanes, helicopters, autogiros, and balloons, and spacecraft for instance can include rockets and rocket powered aircraft. The vehicle can have numerous types of power sources. For instance, the vehicle can be powered via human propulsion, electrically powered, powered via chemical combustion, nuclear powered, and/or solar powered. The direction, velocity, and operation of the vehicle can be human controlled, autonomously controlled, and/or semi-autonomously controlled. Examples of autonomously or semi-autonomously controlled vehicles include Automated Guided Vehicles (AGVs) and drones.

“Web” or “Webbing” generally refers to a strap made of a network of thread, strings, cords, wires, and/or other materials designed to restrain or otherwise hold a person or other object steady such as in a boat, vehicle, aircraft, and/or spacecraft. By way of non-limiting examples, the web can be incorporated into a seat belt, a child booster seat, and/or a car seat.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

100 child safety seat
105 seat bottom
110 seat back
115 seat body
120 harness adjuster
125 harness
130 shoulder belts
132 buckle
135 adjustment belt
305 frame
310 lever assembly
315 shaft
320 sidewalls
405 aperture
410 line
415 base
505 lever portion
510 belt engagement portion
515 insert
520 hump
525 arrow
530 arrow
535 arrow
540 arrow
605 spring
705 spring arm
710 retention opening
805 gap
810 arcuate portion
905 groove
910 cutouts
1005 bore
1105 tongue
1110 teeth
1115 lobes

What is claimed is:

1. A harness adjuster, comprising:
a frame;
a lever assembly; and
a shaft;
wherein the shaft is configured to retain the lever assembly within the frame;
wherein the lever assembly includes a lever portion and a web engagement portion;
wherein the web engagement portion includes a removable insert; and
wherein the lever portion and insert are made from the two different materials.

2. The harness adjuster of claim 1, wherein the lever portion is made from plastic.

3. The harness adjuster of claim 2, wherein the insert is made from metal.

4. The harness adjuster of claim 1, wherein the web engagement portion includes an elongated groove configured to retain the insert via a tongue and groove connection.

5. The harness adjuster of claim 4, wherein the insert includes a tongue portion held within the elongated groove.

6. The harness adjuster of claim 5, wherein the tongue portion includes an arcuate portion configured to prevent rotation of the lever portion when force is applied to a harness webbing.

7. The harness adjuster of claim 1, wherein the harness adjuster is a car seat harness adjuster.

8. A harness adjuster, comprising:
a frame;
a lever assembly; and
a shaft;
wherein the shaft is configured to retain the lever assembly within the frame;
wherein the lever assembly rotates about an axis formed by the shaft; and
wherein the lever portion is made from plastic.

9. The harness adjuster of claim 8, wherein the lever assembly includes a lever portion and a web engagement portion; and wherein the web engagement portion includes an elongated groove configured to retain an insert.

10. The harness adjuster of claim 9, wherein the lever portion and insert are made from the two different materials.

11. The harness adjuster of claim 10, wherein the insert is made from metal.

12. The harness adjuster of claim 9, wherein the insert includes a tongue portion held within the elongated groove; and wherein the tongue portion is configured prevent rotation of the lever portion when force is applied a harness webbing.

13. The harness adjuster of claim 8, wherein the shaft is configured to receive a circumferentially wound spring extending from the lever assembly to the frame.

14. The harness adjuster of claim 13, wherein the spring is configured to bias the insert of the web engagement portion into contact with a harness webbing to prevent movement of the harness webbing.

15. The harness adjuster of claim 8, wherein the harness adjuster is a car seat harness adjuster.

16. The harness adjuster of claim 8, wherein the shaft is made of metal, and the lever portion defines a opening where the shaft is received.
